(19) United States
(12) Patent Application Publication
(10) Pub. No.: US 2020/0061852 A1
(43) Pub. Date: Feb. 27, 2020

(54) SAFETY CHEF KNIFE

(71) Applicant: Ianand Bissoondutt, Greensboro, NC (US)

(72) Inventor: Ianand Bissoondutt, Greensboro, NC (US)

(21) Appl. No.: 16/109,029

(22) Filed: Aug. 22, 2018

(51) Int. Cl. B26B 9/02

(52) U.S. Cl. CPC B26B 9/02

(57) ABSTRACT

The invention relates to a safety knife for cutting food. It has a cutting edge which is angled away from the user's fingers at an angle of about 1-25 degrees relative to the blade.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to chef knives. In particular, the invention relates to a knife designed to be easier to prevent injury during use.

### Description of Related Art

The chef's knife had traditionally been the knife of choice for chefs in American restaurants. The handle is held with one hand, while the fingers of the other hand guide the food toward the blade. Skilled chefs know how to curl their fingers out of the way in a manner that prevents cutting their fingers. However, this is a skill that's learned over time and it is not unusual for chefs to still cut themselves.

In the last couple decades though, home cooks and enthusiast have started to adopt and use restaurant type equipment, including the use of a chef's knife. Unfortunately, most home users do not know how to safely position their fingers to minimize accidental cuts. This results in users frequently cutting themselves, sometimes quite severely. Absent more universal knife training, there is a growing need to have knives that are more difficult to cut oneself with.

### BRIEF SUMMARY OF THE INVENTION

The present invention relates to a knife that is designed to be more difficult to injure oneself when using the knife. It involves providing the cutting edge at an angle to the blade body.

Accordingly, in one embodiment, there is a safety knife having a blade and a cutting edge wherein the cutting edge is offset relative to the blade when the blade is vertical of between about 1 degree and 25 degrees.

### BRIEF DESCRIPTION OF THE DRAWINGS

FIG. 1 is a side perspective view of the knife.

FIG. 2 is a rear facing view of the knife showing the cutting edge bend.

FIG. 3 is a top view of placement of the cutting edge and fingers during use.

FIG. 4 is a side perspective view showing how the knife avoids cutting the user.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “knife” refers to any instrument composed of a blade with a cutting edge wherein the blade is fixed into a handle, which is used for cutting, In one embodiment, the shape of the knife is a chef's knife (shown in the Figures is a chef knife).

As used herein, the term “cutting edge” refers to the bottom edge of the knife blade which is sharpened to a point for the purpose of cutting food. In the present invention, the cutting edge is offset relative to the blade when the blade is vertical of between 1 degree and 25 degrees. This angle effectively positions the cutting edge away from the user's fingers during the cutting process, making even novice knife users less likely to cut themselves during the knife's use.

As used herein, the term “blade” refers to the body of the knife, as shown in the Figures. In regular knives, the cutting edge is in the same plane as the rest of the blade (0 degree offset). In the present invention, the edge is angled.

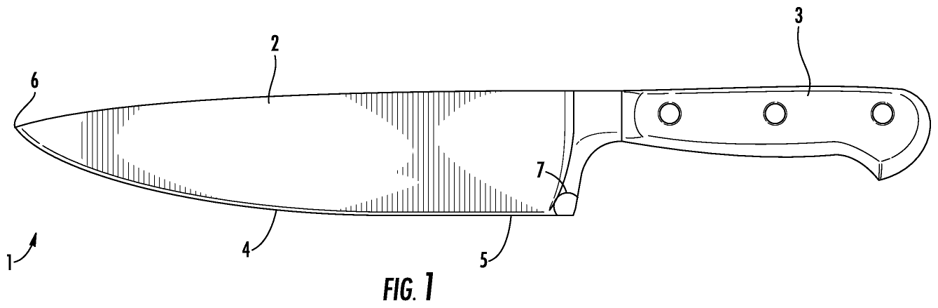

As used herein, the term “chef's knife” refers to the particular restaurant style knife shape, as shown in FIG. 1.

In use, the knife is held in the normal cutting method with the blade perpendicular to the item being cut. The angled blade is positioned away from the user. Accordingly, there would be one knife for right handers and one for left handers. The normal slicing motion (straight down) is used; however with the blade at an angle, it cuts a little off center, but keeps the cutting edge from being able to cut the user if the user's fingers get too close, as shown in the Figures.

### Drawings

Now referring to the drawings, FIG. 1 is a side view of knife 1 in a chef's knife shape. The parts of the knife are as follows. The blade 2 is parallel to handle 3. The cutting edge 4 extends from the heel 5 of the blade to the tip 6 of the blade. The cutting edge 4 is angled (angle shown at 7) toward the viewer, in this embodiment, from about 1 degree to about 25 degrees.

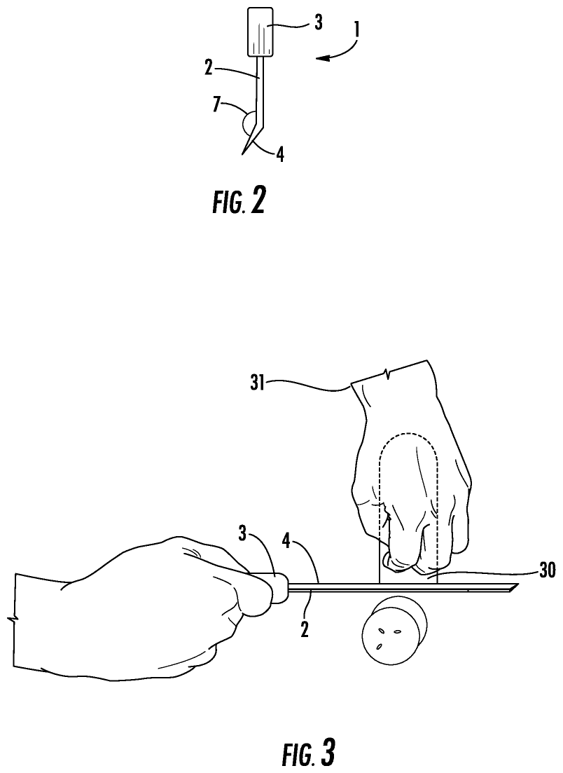

FIG. 2 is a rear perspective view of the knife 1. Handle 3 is closest to the viewer and the angle 7 between the cutting edge 4 and the blade 2 can easily be seen.

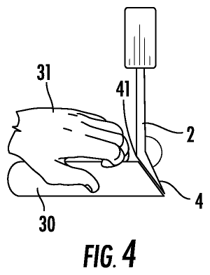

FIG. 3 is a top perspective view of knife 1 cutting cucumber 30 with user's fingers 31 shown advancing the cucumber towards the knife. With the cutting edge 4 being angled away, there is no worry of the fingers getting underneath the blade and cut by the cutting edge. If the fingers move too far forward, the point of the bend in the blade is all that will hit the user's fingers. FIG. 4 notes the fingers 31 underneath the blade, such that when the cut is finished, the bend point 41 is all that will hit the user and not the cutting edge 4.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A safety knife having a blade having a first side and a second side and a cutting edge at the bottom of the first and second side wherein the cutting edge is offset relative to both the first and second side of the blade wherein the offset relative to one of the first side and second side is at an angle of between about 1 degree and 25 degrees relative to the one of the first side and second side.

2. The safety knife according to claim 1 wherein the knife has a chef's knife shape.
